(19) United States
(12) Patent Application Publication
(10) Pub. No.: US 2026/0257778 A1
(43) Pub. Date: Sep. 3, 2026

(54) DEEP-SEA PLATFORM ENERGY SELF-SUPPLY DEVICE AND CONTROL METHOD THEREFOR

(71) Applicant: Jiangsu University of Science and Technology, Zhenjiang (CN)

(72) Inventors: Shiyan SUN, Zhenjiang (CN); Meng WANG, Zhenjiang (CN); Zhen ZHANG, Zhenjiang (CN); Wei CHEN, Zhenjiang (CN)

(21) Appl. No.: 19/653,266

(22) Filed: Apr. 21, 2026

Related U.S. Application Data
(63) Continuation of application No. PCT/CN2025/116912, filed on Aug. 26, 2025.

(30) Foreign Application Priority Data
Jun. 30, 2025 (CN) 202510889319.2

(51) Int. Cl. B63B 35/44; B63B 22/00; F16M 13/02

(52) U.S. Cl. CPC B63B 35/44; B63B 22/00; F16M 13/02; B63B 2035/4466

(57) ABSTRACT

A deep-sea platform energy self-supply device and a control method therefor are disclosed. The device includes a working platform of a deep-sea platform, buoys mounted at a bottom of the working platform, wave energy piezoelectric assemblies disposed at the bottom of the working platform, and ocean current energy piezoelectric assemblies disposed at bottoms of the buoys. The present disclosure directly converts kinetic energy of fluid in the ocean into electric energy by using a wave energy piezoelectric plate and an ocean current energy piezoelectric plate, thereby supplying power to the deep-sea platform and achieving energy self-supply for the deep-sea platform. The device also dissipates kinetic energy of the fluid, such that the amplitude of waves decreases as the kinetic energy of the fluid decreases, thereby achieving a wave-dissipating effect, enhancing operational stability of the working platform, and extending the service life of the working platform.

### TECHNICAL FIELD

The present disclosure relates to deep-sea platforms, and more particularly to a deep-sea platform energy self-supply device and a control method therefor.

### BACKGROUND

Currently, energy supply for deep-sea platforms mainly relies on high-density batteries and external cables. However, many challenges exist in cost control and environmental protection through the above methods of energy supply. To achieve sustainable development of deep-sea platforms, energy self-supply has become a key breakthrough. Gradually replacing traditional high-density battery power supply modes by utilizing renewable energy sources such as offshore wind energy, solar energy, ocean current energy, and wave energy, and combining high-efficiency energy conversion technologies is an important development direction in energy supply for deep-sea platforms in the future. The development and application of energy self-supply technology for deep-sea platforms not only have significant economic value, but also have profound environmental significance in promoting the energy structure transformation, achieving global carbon neutrality goals, and fostering sustainable development.

In the prior art, in addition to challenges in energy supply for deep-sea platforms, it is also necessary to withstand extremely harsh natural conditions. Deep-sea areas suffer from year-round impacts by strong winds, huge waves, and complex ocean currents, and various environmental factors interact with each other to form complex dynamic loads, posing a serious threat to structural safety of deep-sea platforms.

### SUMMARY

Invention objective: A first objective of the present disclosure is to provide a deep-sea platform energy self-supply device capable of mitigating impacts of dynamic loads on a platform while utilizing kinetic energy of fluid.

A second objective of the present disclosure is to provide a control method for the deep-sea platform energy self-supply device.

Technical solution: In one aspect, the present disclosure provides a deep-sea platform energy self-supply device including a working platform of a deep-sea platform, buoys mounted at a bottom of the working platform, wave energy piezoelectric assemblies disposed at the bottom of the working platform and movable around an outer periphery of the buoys so as to dissipate wave energy and convert the wave energy into electric energy, and ocean current energy piezoelectric assemblies disposed at bottoms of the buoys so as to dissipate ocean current energy and convert the ocean current energy into electric energy. Each wave energy piezoelectric assembly includes an electric slide rail mounted at the bottom of the working platform and arranged around the outer periphery of the buoys, a liftable support connector connected to a slider of the electric slide rail, four first claw members arranged in a rectangular array and mounted on the support connector, and a wave energy piezoelectric plate detachably connected to one of the first claw members and rotatable about a central axis of a joint between the one of the first claw members and the wave energy piezoelectric plate.

Further, the support connector includes a mounting plate fixedly connected to the slider of the electric slide rail, a first hydraulic cylinder hinged to a bottom end of the mounting plate, a second hydraulic cylinder disposed directly below the first hydraulic cylinder, and an undamped double-acting hydraulic cylinder located between the first hydraulic cylinder and the second hydraulic cylinder, with both ends of the undamped double-acting hydraulic cylinder fixedly connected to movable ends of the first hydraulic cylinder and the second hydraulic cylinder respectively.

Further, the support connector further includes a third hydraulic cylinder, the third hydraulic cylinder is arranged obliquely, both ends of the third hydraulic cylinder are hinged to the mounting plate and a movable end of the first hydraulic cylinder respectively, and the third hydraulic cylinder is located on a side of the first hydraulic cylinder close to the buoys.

Further, the first claw member includes a fourth hydraulic cylinder arranged obliquely with one end hinged to a fixed end of the second hydraulic cylinder, a fifth hydraulic cylinder hinged to a movable end of the fourth hydraulic cylinder, a first connecting rod arranged perpendicular to the fifth hydraulic cylinder and fixedly connected to a movable end of the fifth hydraulic cylinder, an electromagnetic plate fixedly connected to the other end of the first connecting rod, and a connecting shaft fixedly connected to the electromagnetic plate, where the connecting shaft is movably connected to a connecting hole formed in a side surface of the wave energy piezoelectric plate in an inserted manner; and the electromagnetic plate is electromagnetically connected to a magnetic sheet fixedly disposed on the side surface of the wave energy piezoelectric plate.

Further, the ocean current energy piezoelectric assembly includes a bottom chamber fixedly connected to a bottom end of the buoy and provided with an opening at a bottom of the bottom chamber, a motor fixedly mounted in the bottom chamber, a sixth hydraulic cylinder connected to an output shaft of the motor via a coupling, two second claw members symmetrically mounted on the sixth hydraulic cylinder, and an ocean current energy piezoelectric plate mounted between the two second claw members with an adjustable angle.

Further, the second claw member includes a seventh hydraulic cylinder with one end fixedly connected to the sixth hydraulic cylinder, a second connecting rod arranged perpendicular to the seventh hydraulic cylinder and fixedly connected to a movable end of the seventh hydraulic cylinder, a connecting plate fixedly connected to the other end of the second connecting rod, and a limiter detachably mounted on the connecting plate, where the limiter is connected to a slot formed on the ocean current energy piezoelectric plate in an inserted manner.

Based on the same inventive concept, the present disclosure further provides a control method for the deep-sea platform energy self-supply device, including the following steps:

S1: acquiring current marine condition in real time through detection equipment for the deep-sea platform;

S2: determining whether the marine condition belongs to a preset operating condition, and if yes, adjusting the wave energy piezoelectric assembly and the ocean current energy piezoelectric assembly to an operating state; and if not, adjusting the wave energy piezoelectric assembly and the ocean current energy piezoelectric assembly to a stowed state; and

S3: when the wave energy piezoelectric assembly and the ocean current energy piezoelectric assembly are in the operating state, wave impact causes mechanical deformation of the wave energy piezoelectric plate, and the wave energy piezoelectric plate converts mechanical energy into electric energy; and ocean current impact causes mechanical deformation of the ocean current energy piezoelectric plate, such that the ocean current energy piezoelectric plate converts mechanical energy into electric energy.

Further, the marine condition in the S1 includes an ocean current velocity v and a wave amplitude γ; and the operating condition in the S2 includes 0.05 m/s<v<1.04 m/s and 0.1 m<γ<1 m.

Further, a method for adjusting the wave energy piezoelectric assembly to the operating state in the S2 is as follows:
controlling the electric slide rail according to a current wave direction to move the wave energy piezoelectric plate to a position facing the wave direction;
selecting the first claw member on a right side of the wave energy piezoelectric plate facing the wave direction according to the current wave direction to connect with the wave energy piezoelectric plate, and releasing other first claw members, where the first claw members are released by disconnecting the power supply for the electromagnetic plate; controlling the fifth hydraulic cylinder and the fourth hydraulic cylinder to extend to move the first connecting rod away from the wave energy piezoelectric plate until the connecting shaft disengages from the wave energy piezoelectric plate;
disconnecting the power supply for the electromagnetic plate of the first claw member connected to the wave energy piezoelectric plate, rotating the wave energy piezoelectric plate to tilt toward the wave direction, and then reconnecting the power supply for the electromagnetic plate of the first claw member to fix the wave energy piezoelectric plate at a current position;
controlling the first hydraulic cylinder and the second hydraulic cylinder to lower the wave energy piezoelectric plate until a draft depth of the wave energy piezoelectric plate is half of a height of the wave energy piezoelectric plate; and
a method for adjusting the wave energy piezoelectric assembly to a stowed state in the S2 includes: controlling the first hydraulic cylinder and the second hydraulic cylinder to lift the wave energy piezoelectric plate linearly to a limit position, and then controlling the third hydraulic cylinder and the first hydraulic cylinder to move the wave energy piezoelectric plate toward the working platform to the limit position.

Further, a method for adjusting the ocean current energy piezoelectric assembly to the operating state in the S2 is as follows:
selecting the limiter with a corresponding angle according to a current ocean current velocity and mounting the limiter on the connecting plate, and mounting the ocean current energy piezoelectric plate between the two second claw members through the limiter and the slot; when 0.05 m/s<v≤0.4 m/s, selecting the limiter with an angle of 60°; when 0.4 m/s<v≤0.7 m/s, selecting the limiter with an angle of 45°; when 0.7 m/s<v≤1.04 m/s, selecting the limiter with an angle of 30°;
controlling the motor to move the ocean current energy piezoelectric plate to a position facing the wave direction according to the current wave direction;
controlling the sixth hydraulic cylinder to lower the ocean current energy piezoelectric plate to an exterior of the bottom chamber; and
a method for adjusting the ocean current energy piezoelectric assembly to a stowed state in the S2 includes: controlling the sixth hydraulic cylinder to lift the ocean current energy piezoelectric plate into the bottom chamber.

Beneficial effects: Compared with the prior art, the present disclosure provides the following advantages. The present disclosure directly converts kinetic energy of fluid in the ocean into electric energy through the wave energy piezoelectric plate and the ocean current energy piezoelectric plate, thereby supplying power to the deep-sea platform and achieving energy self-supply for the deep-sea platform. During conversion of the kinetic energy of the fluid into electric energy, the device also dissipates the kinetic energy of the fluid, such that the amplitude of waves naturally decreases as the kinetic energy of the fluid decreases, thereby achieving a wave-dissipating effect, improving operational stability of the working platform, and extending service life of the working platform. In addition, the wave energy piezoelectric plate and the ocean current energy piezoelectric plate are adjustable in angle and height, thereby improving energy conversion efficiency. When not in use, the wave energy piezoelectric plate and the ocean current energy piezoelectric plate can be stored in a relatively safe and stable environment, thereby reducing storage and repair difficulty and extending overall service life.

The wave energy piezoelectric plate and the ocean current energy piezoelectric plate of the present disclosure are adjustable in angles and heights, which effectively improves the energy conversion efficiency; and when not used, the wave energy piezoelectric plate and the ocean current energy piezoelectric plate are capable of being stored in a relatively safe and stable environment, thereby reducing the overall difficulty of stowed and repair, and extending the overall service life.

### BRIEF DESCRIPTION OF THE DRAWINGS

FIG. 1 is a schematic structural view of the present disclosure.

FIG. 2 is a partial schematic structural view of an electric slide rail of the present disclosure.

FIG. 3 is a partial schematic structural view of a wave energy piezoelectric assembly of the present disclosure.

FIG. 4 is a schematic structural view of a first claw member and a wave energy piezoelectric plate of the present disclosure.

FIG. 5 is a schematic structural view of the wave energy piezoelectric assembly in a stowed state.

FIG. 6 is a schematic structural view of an ocean current energy piezoelectric assembly of the present disclosure.

FIG. 7 is a sectional view of a bottom chamber of the present disclosure.

FIG. 8 is a schematic structural view of a second claw member and an ocean current energy piezoelectric plate of the present disclosure.

FIG. 9 is a schematic structural view of a connecting plate and a limiter of the present disclosure.

FIG. 10 is a schematic theoretical calculation model view of a wave energy piezoelectric plate according to an embodiment of the present disclosure.

FIG. 11 is a schematic view of strain energy efficiency when a wave energy piezoelectric plate is fixed to first claw members on different sides according to an embodiment of the present disclosure.

### DETAILED DESCRIPTIONS OF THE EMBODIMENTS

The technical solution of the present disclosure will be further described below in combination with the accompanying drawings.

### Embodiment 1

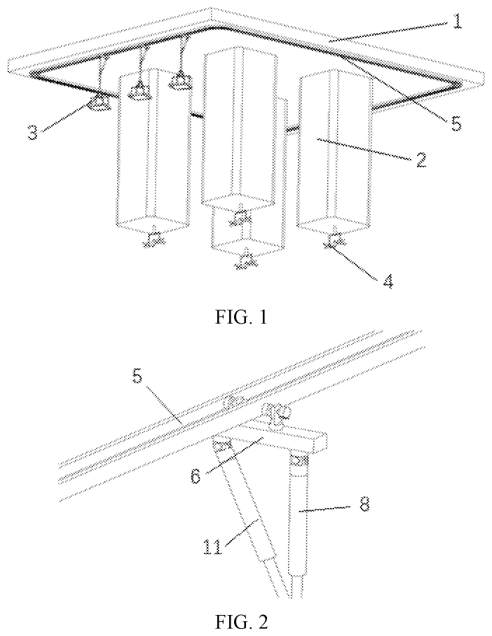

A deep-sea platform energy self-supply device disclosed in the present disclosure, as shown in FIG. 1, includes a working platform 1 of a deep-sea platform, buoys 2, wave energy piezoelectric assemblies 3, and ocean current energy piezoelectric assemblies 4; a plurality of buoys 2 are provided, and the plurality of buoys 2 distributed in a matrix array manner are fixedly mounted at a bottom of the working platform 1; the wave energy piezoelectric assemblies 3 are disposed at the bottom of the working platform 1 and surround an outer periphery of the buoys 2, and the wave energy piezoelectric assemblies 3 are capable of dissipating ocean wave energy and converting wave energy into electric energy; and the ocean current energy piezoelectric assemblies 4 are disposed at bottoms of the buoys 2, and the ocean current energy piezoelectric assemblies 4 are capable of dissipating ocean current energy and converting the ocean current energy into electric energy. In actual use, conversion equipment and electric energy storage equipment compatible with the wave energy piezoelectric assemblies 3 and the ocean current energy piezoelectric assemblies 4 are mounted on the deep-sea platform, and electric energy generated by the wave energy piezoelectric assemblies 3 under the action of waves and electric energy generated by the ocean current energy piezoelectric assemblies 4 under the action of ocean currents are processed by the conversion equipment and then stored in the storage equipment to supply power to the deep-sea platform. The wave energy piezoelectric assemblies 3 convert potential energy of wave impact into electric energy, the ocean current energy piezoelectric assemblies 4 convert potential energy of ocean current impact into electric energy, the wave energy piezoelectric assemblies 3 and the ocean current energy piezoelectric assemblies 4 are capable of generating electricity by utilizing the potential energy of ocean waves and ocean currents, and the wave energy piezoelectric assemblies 3 and the ocean current energy piezoelectric assemblies 4 are also capable of dissipating kinetic energy of fluid in the ocean, such that an amplitude of waves naturally decreases with the reduction of kinetic energy of fluid, thereby achieving a wave-dissipating effect, i.e., reducing fatigue damage caused by wave forces to the working platform 1, which is conducive to enhancing operation stability of the working platform 1 and extending the service life of the working platform 1.

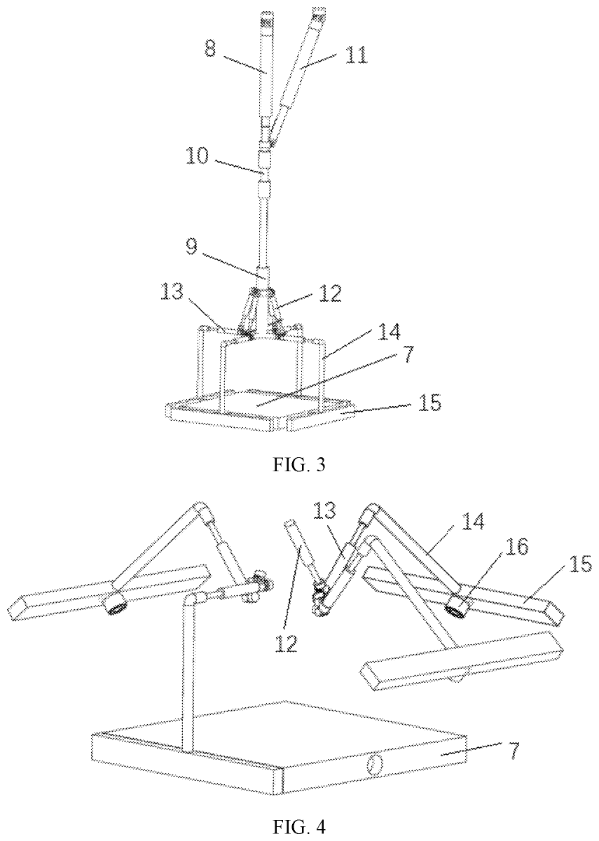

As shown in FIGS. 1 to 4, the wave energy piezoelectric assembly 3 includes an electric slide rail 5, a mounting plate 6, a wave energy piezoelectric plate 7, a first hydraulic cylinder 8, a second hydraulic cylinder 9, an undamped double-acting hydraulic cylinder 10, a third hydraulic cylinder 11, a fourth hydraulic cylinder 12, a fifth hydraulic cylinder 13, a first connecting rod 14, an electromagnetic plate 15, and a connecting shaft 16, where the electric slide rail 5 is mounted at the bottom of the working platform 1, and the electric slide rail 5 is arranged around the outer periphery of the buoys 2. The mounting plate 6, the first hydraulic cylinder 8, the second hydraulic cylinder 9, the undamped double-acting hydraulic cylinder 10, and the third hydraulic cylinder 11 constitute a support connector, the support connector is mounted on a slider of the electric slide rail 5, the mounting plate 6 is fixedly connected to the slider of the electric slide rail 5, and a fixed end of the first hydraulic cylinder 8 is hinged to the mounting plate 6; the second hydraulic cylinder 9 is located directly below the first hydraulic cylinder 8, the undamped double-acting hydraulic cylinder 10 is located between the first hydraulic cylinder 8 and the second hydraulic cylinder 9, and both ends of the undamped double-acting hydraulic cylinder are fixedly connected to movable ends of the first hydraulic cylinder and the second hydraulic cylinder respectively; and the third hydraulic cylinder 11 is located on a side of the first hydraulic cylinder 8 close to the buoys 2, the third hydraulic cylinder 11 is obliquely arranged, and both ends of the third hydraulic cylinder are hinged to the mounting plate 6 and a movable end of the first hydraulic cylinder 8 respectively. The fourth hydraulic cylinder 12, the fifth hydraulic cylinder 13, the first connecting rod 14, the electromagnetic plate 15, and the connecting shaft 16 constitute a first claw member, the first claw member is detachably connected to the wave energy piezoelectric plate 7, four first claw members are arranged, and the four first claw members are distributed in a matrix array manner, that is, each of the first claw members is detachably connected to a side of the wave energy piezoelectric plate 7; and when the wave energy piezoelectric plate 7 is connected to one of the first claw members or two symmetrical first claw members separately, the wave energy piezoelectric plate 7 is capable of rotating relative to the first claw member about a central axis of a joint between the first claw member and the wave energy piezoelectric plate. The fourth hydraulic cylinder 12 is obliquely arranged, the fourth hydraulic cylinder 12 is hinged to a fixed end of the second hydraulic cylinder 9, a hoop is mounted on a fixed portion of the second hydraulic cylinder 9, and the fourth hydraulic cylinder 12 is hinged to the hoop; the fifth hydraulic cylinder 13 is hinged to a movable end of the fourth hydraulic cylinder 12, a fixed end of the fifth hydraulic cylinder 13 is hinged to the fixed end of the second hydraulic cylinder 9, and the first connecting rod 14 is vertically arranged with the fourth hydraulic cylinder 12; one end of the first connecting rod 14 is fixedly connected to a movable end of the fifth hydraulic cylinder 13, the electromagnetic plate 15 is fixedly connected to the other end of the first connecting rod 14, and the connecting shaft 16 is fixedly connected to the electromagnetic plate 15; and a connecting hole for movable insertion of the connecting shaft 16 is formed on a side surface of the wave energy piezoelectric plate 7, and a magnetic sheet adapted to the electromagnetic plate 15 is disposed on the side surface of the wave energy piezoelectric plate 7. The electric slide rail 5 is arranged around the outer periphery of the buoys 2, such that the wave energy piezoelectric plate 7 is disposed on the outer periphery of the buoys 2, which prevents the buoys 2 from blocking ocean waves and dissipates the energy of ocean wave impact on the wave energy piezoelectric plate 7.

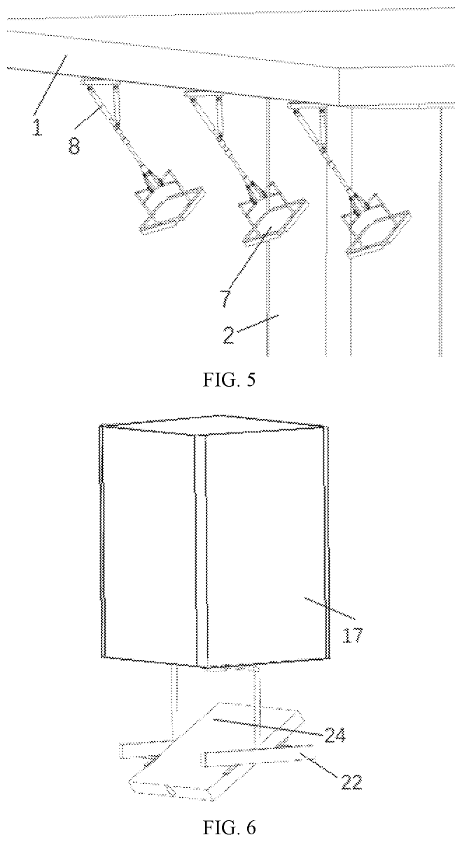

When the wave energy piezoelectric assembly 3 is in a non-operating state, due to extreme weather or no waves in the ocean, the four first claw members are respectively connected to four side surfaces of the wave energy piezoelectric plate 7, and the electromagnetic plates 15 of the four first claw members are in an energized state, such that the electromagnetic plates 15 adsorb and fix the wave energy piezoelectric plate 7 through the magnetic sheets, the electromagnetic plates 15 are alternatively in a de-energized state, and the four connecting shafts 16 are respectively connected to the four side surfaces of the wave energy piezoelectric plate 7 to ensure stability; and cooperatively controlling the third hydraulic cylinder 11 and the first hydraulic cylinder 8 causes the first claw members to drive the wave energy piezoelectric plate 7 to move vertically to a highest limit position, then cooperating with the third hydraulic cylinder 11 and the first hydraulic cylinder 8 causes the first claw members to drive the wave energy piezoelectric plate 7 to move toward the buoys 2 to a limit position, and finally the wave energy piezoelectric plate 7 is stored at a current position, which, as shown in FIG. 5, reduces the damage of extreme weather to the wave energy piezoelectric plate 7 and protects the wave energy piezoelectric plate 7. To use the wave energy piezoelectric assembly 3 as needed, the electric slide rail 5 is controlled to move the wave energy piezoelectric plate 7 to a position facing the wave direction according to a current wave direction; then the first claw member on a right side of the wave energy piezoelectric plate 7 facing the wave direction is selected to connect with the wave energy piezoelectric plate, and other first claw members are released, where the first claw members are released by disconnecting the power supply for the electromagnetic plate 15; the fifth hydraulic cylinder 13 and the fourth hydraulic cylinder 12 are controlled to extend to move the first connecting rod 14 away from the wave energy piezoelectric plate 7 until the connecting shaft 16 disengages from the wave energy piezoelectric plate 7; preferably, the fifth hydraulic cylinder 13 and the fourth hydraulic cylinder 12 of the first claw member disengaged from the wave energy piezoelectric plate 7 are controlled to rotate the corresponding electromagnetic plates 15 upward until the electromagnetic plates 15 are not in contact with a sea surface, which prevent the electromagnetic plates 15 located around the wave energy piezoelectric plate 7 from affecting the ocean wave impact on the wave energy piezoelectric plate 7; then an angle of the wave energy piezoelectric plate 7 is adjusted by rotating, the power supply for the electromagnetic plate 15 of the first claw member connected to the wave energy piezoelectric plate 7 is disconnected, the wave energy piezoelectric plate 7 rotates and tilts toward the wave direction, and then the power supply for the electromagnetic plate 15 of the first claw member is reconnected to fix the wave energy piezoelectric plate 7 at the current position; and cooperatively controlling the third hydraulic cylinder 11 and the first hydraulic cylinder 8 causes the first claw members to drive the wave energy piezoelectric plate 7 to move toward the buoys 2 to the limit position (i.e., the first hydraulic cylinder 8 is in a vertical state), and then cooperatively controlling the third hydraulic cylinder 11 and the first hydraulic cylinder 8 causes the first claw members to drive the wave energy piezoelectric plate 7 to move linearly downward until a draft depth of the wave energy piezoelectric plate 7 is half of a height of the wave energy piezoelectric plate 7; and wave impact causes mechanical deformation of the wave energy piezoelectric plate 7, the wave energy piezoelectric plate 7 converts mechanical energy into electric energy, and the arrangement of the undamped double-acting hydraulic cylinder 10 causes the wave energy piezoelectric plate 7 to move up and down with ocean waves within a certain range based on a current height, so as to cooperate with the ocean wave impact on the wave energy piezoelectric plate 7.

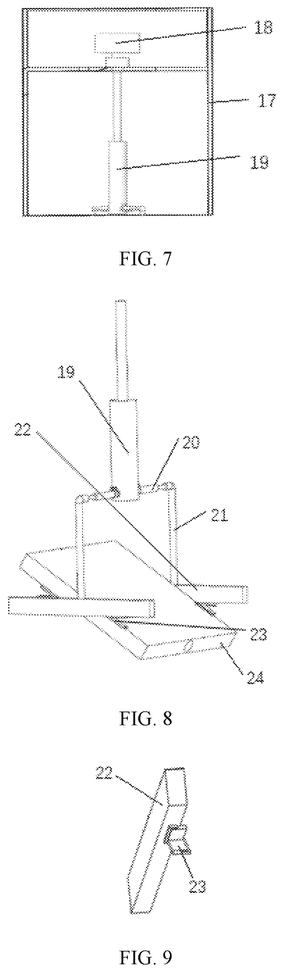

As shown in FIGS. 1, 6 to 9, the ocean current energy piezoelectric assembly 4 includes a bottom chamber 17, a motor 18, a sixth hydraulic cylinder 19, a seventh hydraulic cylinder 20, a second connecting rod 21, a connecting plate 22, a limiter 23, and an ocean current energy piezoelectric plate 24; the bottom chamber 17 is fixedly connected to a bottom end of the buoy 2, a bottom of the bottom chamber 17 is provided with an opening, the motor 18 is fixedly mounted in the bottom chamber 17, and the sixth hydraulic cylinder 19 is fixedly connected to an output shaft of the motor 18 through a coupling; the seventh hydraulic cylinder 20, the second connecting rod 21, the connecting plate 22, and the limiter 23 constitute a second claw member, two second claw members are arranged in total, and the two second claw members are symmetrically arranged about a central axis of the ocean current energy piezoelectric assembly 4; one end of the seventh hydraulic cylinder 20 is fixedly connected to the sixth hydraulic cylinder 19, the second connecting rod 21 is vertically arranged with the seventh hydraulic cylinder 20, and the second connecting rod 21 is fixedly connected to a movable end of the seventh hydraulic cylinder 20; the connecting plate 22 is fixedly connected to the other end of the second connecting rod 21, the limiter 23 is detachably connected to the connecting plate 22, a slot configured for insertion of the limiter 23 is formed in the ocean current energy piezoelectric plate 24, and the limiter 23 is composed of two plate-shaped bodies with a certain included angle; and in use, the limiter 23 with a corresponding angle may be selected to connect with the connecting plate 22 according to an ocean current velocity, and after the limiter 23 with the corresponding angle is connected to the ocean current energy piezoelectric plate 24, the ocean current energy piezoelectric plate 24 is placed at different tilt angles, thereby increasing an area or force of ocean currents acting on the ocean current energy piezoelectric plate 24. The wave energy piezoelectric plate 7 and the ocean current energy piezoelectric plate 24 are structurally identical, and the two piezoelectric plates are mature technical products containing piezoelectric materials in the prior art.

When the ocean current energy piezoelectric assembly 4 is in a non-operating state, due to extreme weather or no waves in the ocean, the sixth hydraulic cylinder 19 contracts under control to move the second claw members and the ocean current energy piezoelectric plate 24 into the bottom chamber 17, and under extreme weather conditions, the bottom chamber 17 provides a relatively stable environment for the second claw members and the ocean current energy piezoelectric plate 24, which is conducive to protecting the second claw members and the ocean current energy piezoelectric plate 24. To use the ocean current energy piezoelectric assembly 4 as needed, the limiter 23 with a corresponding angle is selected according to a current ocean current velocity and mounted on the connecting plate 22, the ocean current energy piezoelectric plate 24 is adjusted to a corresponding tilt angle, the motor 18 is controlled to move the ocean current energy piezoelectric plate 24 to a position facing the wave direction, and ocean current impact causes mechanical deformation of the ocean current energy piezoelectric plate 24, such that the ocean current energy piezoelectric plate 24 converts mechanical energy into electric energy.

### Embodiment 2

A control method for a deep-sea platform energy self-supply device is disclosed in the present disclosure, including the following steps:
S1: Current marine condition is acquired in real time through detection equipment for the deep-sea platform, where the marine condition includes an ocean current velocity v and a wave amplitude γ.
S2: Whether the marine condition belongs to a preset operating condition is determined, and if yes, the wave energy piezoelectric assembly 3 and the ocean current energy piezoelectric assembly 4 are adjusted to an operating state; and if not, the wave energy piezoelectric assembly 3 and the ocean current energy piezoelectric assembly 4 are adjusted to a stowed state. The operating condition is 0.05 m/s<v<1.04 m/s and 0.1 m<γ<1 m.

A method for adjusting the wave energy piezoelectric assembly 3 to the operating state is as follows:

The electric slide rail 5 is controlled according to a current wave direction to move the wave energy piezoelectric plate 7 to a position facing the wave direction.

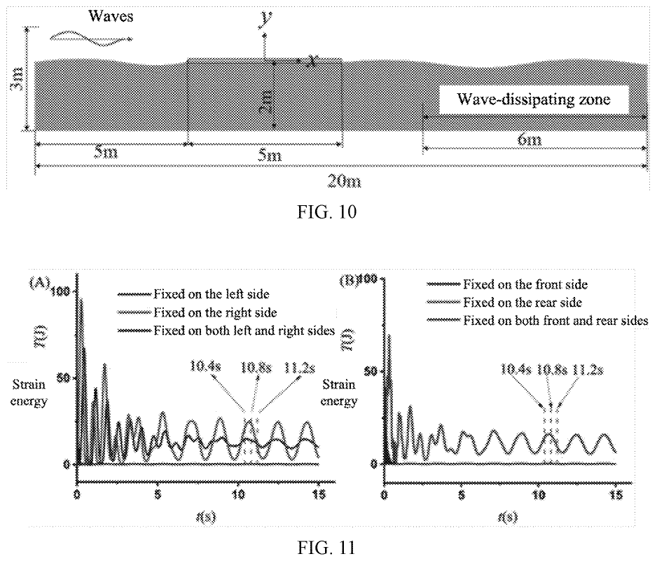

The first claw member on a right side of the wave energy piezoelectric plate 7 facing the wave direction is selected according to the current wave direction to connect with the wave energy piezoelectric plate, and other first claw members are released, where the first claw members are released by disconnecting the power supply for the electromagnetic plate 15; the fifth hydraulic cylinder 13 and the fourth hydraulic cylinder 12 are controlled to extend to move the first connecting rod 14 away from the wave energy piezoelectric plate 7 until the connecting shaft 16 disengages from the wave energy piezoelectric plate 7; and preferably, the fifth hydraulic cylinder 13 and the fourth hydraulic cylinder 12 of the first claw member disengaged from the wave energy piezoelectric plate 7 are controlled to rotate the corresponding electromagnetic plates 15 upward until the electromagnetic plates 15 are not in contact with a sea surface, which prevent the electromagnetic plates 15 located around the wave energy piezoelectric plate 7 from affecting the ocean wave impact on the wave energy piezoelectric plate 7. The first claw member on the right side of the wave energy piezoelectric plate 7 facing the wave direction is selected to connect with the wave energy piezoelectric plate because tests show that the energy conversion efficiency is the highest when the wave energy piezoelectric plate 7 is fixed on the right side facing the wave direction, and the test results are shown in FIG. 11. A test method in the present embodiment is as follows: A relationship between a piezoelectric plate fixing method and piezoelectric efficiency through a theoretical calculation method; in calculation, a finite volume method is used to discretize a computational domain, a volume of fluid (VOF) method is used to capture a free liquid surface, and a RANS equation and a continuity equation are combined to control fluid flow; to improve the calculation efficiency, as shown in FIG. 10, computational domain dimensions are as follows: a length of 20 m, a width of 10 m, a height of 3 m, a water depth of 2 m; wave energy plate dimensions are as follows: a length of 5 m, a width of 5 m, a height of 0.2 m; and the wave energy plate has a draft of 0.1 m and is symmetrical with the computational domain in a width direction. In a length direction of the computational domain, a top wave-making inlet is 5 m away from the piezoelectric plate, and a tail wave absorption zone is 6 m long.

The power supply for the electromagnetic plate 15 of the first claw member connected to the wave energy piezoelectric plate 7 is disconnected, the wave energy piezoelectric plate 7 rotates and tilts toward the wave direction, and then the power supply for the electromagnetic plate 15 of the first claw member is reconnected to fix the wave energy piezoelectric plate 7 at a current position.

The first hydraulic cylinder 8 and the second hydraulic cylinder 9 are controlled to lower the wave energy piezoelectric plate 7 until a draft depth of the wave energy piezoelectric plate 7 is half of a height of the wave energy piezoelectric plate.

A method for adjusting the wave energy piezoelectric assembly 3 to a stowed state includes: the first hydraulic cylinder 8 and the second hydraulic cylinder 9 are controlled to lift the wave energy piezoelectric plate 7 linearly to a limit position, and then the third hydraulic cylinder 11 and the first hydraulic cylinder 8 are controlled to move the wave energy piezoelectric plate 7 toward the working platform 1 to the limit position. Finally, the wave energy piezoelectric plate 7 is stored at a current position, which reduces the damage of extreme weather to the wave energy piezoelectric plate 7 and protects the wave energy piezoelectric plate 7.

A method for adjusting the ocean current energy piezoelectric assembly 4 to the operating state is as follows:

The limiter 23 with a corresponding angle is selected according to a current ocean current velocity and mounted on the connecting plate 22, and the ocean current energy piezoelectric plate 24 is mounted between the two second claw members through the limiter 23 and the slot; when 0.05 m/s<v≤0.4 m/s, the limiter 23 with an angle of 60° is selected; when 0.4 m/s<v≤0.7 m/s, the limiter 23 with an angle of 45° is selected; when 0.7 m/s<v≤1.04 m/s, the limiter 23 with an angle of 30° is selected; the motor 18 is controlled to move the ocean current energy piezoelectric plate 24 to a position facing the wave direction according to the current wave direction; and the sixth hydraulic cylinder 19 is controlled to lower the ocean current energy piezoelectric plate 24 to an exterior of the bottom chamber 17.

A method for adjusting the ocean current energy piezoelectric assembly 4 to the stowed state includes: the sixth hydraulic cylinder 19 is controlled to lift the ocean current energy piezoelectric plate 24 into the bottom chamber 17. Under extreme weather conditions, the bottom chamber 17 provides a relatively stable environment for the second claw members and the ocean current energy piezoelectric plate 24, which is conducive to protecting the second claw members and the ocean current energy piezoelectric plate 24.

S3: When the wave energy piezoelectric assembly 3 and the ocean current energy piezoelectric assembly 4 are in the operating state, wave impact causes mechanical deformation of the wave energy piezoelectric plate 7, and the wave energy piezoelectric plate 7 converts mechanical energy into electric energy; and ocean current impact causes mechanical deformation of the ocean current energy piezoelectric plate 24, such that the ocean current energy piezoelectric plate 24 converts mechanical energy into electric energy.

What is claimed is:

1. A deep-sea platform energy self-supply device, comprising:
a working platform (1) of a deep-sea platform;
buoys (2) mounted at a bottom of the working platform (1);
wave energy piezoelectric assemblies (3) disposed at the bottom of the working platform (1), movable around an outer periphery of the buoys (2), and configured to dissipate wave energy and convert the wave energy into electric energy; and
ocean current energy piezoelectric assemblies (4) disposed at bottoms of the buoys (2) and configured to dissipate ocean current energy and convert the ocean current energy into electric energy,
wherein each wave energy piezoelectric assembly (3) comprises an electric slide rail (5) mounted at the bottom of the working platform (1) and arranged around the outer periphery of the buoys (2), a liftable support connector connected to a slider of the electric slide rail (5), four first claw members arranged in a rectangular array and mounted on the support connector, and a wave energy piezoelectric plate (7) detachably connected to one of the first claw members and rotatable about a central axis of a joint between the one of the first claw members and the wave energy piezoelectric plate (7).

2. The deep-sea platform energy self-supply device according to claim 1, wherein the support connector comprises a mounting plate (6) fixedly connected to the slider of the electric slide rail (5), a first hydraulic cylinder (8) hinged to a bottom end of the mounting plate (6), a second hydraulic cylinder (9) disposed directly below the first hydraulic cylinder (8), and an undamped double-acting hydraulic cylinder (10) located between the first hydraulic cylinder (8) and the second hydraulic cylinder (9), opposite ends of the undamped double-acting hydraulic cylinder (10) being fixedly connected to movable ends of the first hydraulic cylinder (8) and the second hydraulic cylinder (9), respectively.

3. The deep-sea platform energy self-supply device according to claim 2, wherein the support connector further comprises a third hydraulic cylinder (11), the third hydraulic cylinder (11) being arranged obliquely, opposite ends of the third hydraulic cylinder (11) being hinged to the mounting plate (6) and a movable end of the first hydraulic cylinder (8), respectively, and the third hydraulic cylinder (11) being located on a side of the first hydraulic cylinder (8) close to the buoys (2).

4. The deep-sea platform energy self-supply device according to claim 2, wherein each first claw member comprises a fourth hydraulic cylinder (12) arranged obliquely with one end hinged to a fixed end of the second hydraulic cylinder (9), a fifth hydraulic cylinder (13) hinged to a movable end of the fourth hydraulic cylinder (12), a first connecting rod (14) arranged perpendicular to the fifth hydraulic cylinder (13) and fixedly connected to a movable end of the fifth hydraulic cylinder (13), an electromagnetic plate (15) fixedly connected to the other end of the first connecting rod (14), and a connecting shaft (16) fixedly connected to the electromagnetic plate (15), wherein the connecting shaft (16) is movably inserted into a connecting hole formed in a side surface of the wave energy piezoelectric plate (7), and the electromagnetic plate (15) is electromagnetically connected to a magnetic sheet fixedly disposed on the side surface of the wave energy piezoelectric plate (7).

5. The deep-sea platform energy self-supply device according to claim 1, wherein each ocean current energy piezoelectric assembly (4) comprises a bottom chamber (17) fixedly connected to a bottom end of the buoy (2) and provided with an opening at a bottom thereof, a motor (18) fixedly mounted in the bottom chamber (17), a sixth hydraulic cylinder (19) connected to an output shaft of the motor (18) via a coupling, two second claw members symmetrically mounted on the sixth hydraulic cylinder (19), and an ocean current energy piezoelectric plate (24) mounted between the two second claw members at an adjustable angle.

6. The deep-sea platform energy self-supply device according to claim 5, wherein each second claw member comprises a seventh hydraulic cylinder (20) having one end fixedly connected to the sixth hydraulic cylinder (19), a second connecting rod (21) arranged perpendicular to the seventh hydraulic cylinder (20) and fixedly connected to a movable end of the seventh hydraulic cylinder (20), a connecting plate (22) fixedly connected to the other end of the second connecting rod (21), and a limiter (23) detachably mounted on the connecting plate (22), wherein the limiter (23) is inserted into and connected to a slot formed on the ocean current energy piezoelectric plate (24).

7. A control method for the deep-sea platform energy self-supply device according to any one of claims 1-6, comprising:
S1, acquiring a current marine condition in real time through detection equipment for the deep-sea platform;
S2, determining whether the current marine condition falls within a preset operating condition, and, if so, adjusting the wave energy piezoelectric assembly (3) and the ocean current energy piezoelectric assembly (4) to an operating state, and otherwise adjusting the wave energy piezoelectric assembly (3) and the ocean current energy piezoelectric assembly (4) to a stowed state; and
S3, when the wave energy piezoelectric assembly (3) and the ocean current energy piezoelectric assembly (4) are in the operating state, causing, by wave impact, mechanical deformation of the wave energy piezoelectric plate (7) so that the wave energy piezoelectric plate (7) converts mechanical energy into electric energy, and causing, by ocean current impact, mechanical deformation of the ocean current energy piezoelectric plate (24) so that the ocean current energy piezoelectric plate (24) converts mechanical energy into electric energy.

8. The control method according to claim 7, wherein the marine condition in S1 comprises an ocean current velocity v and a wave amplitude γ, and the preset operating condition in S2 comprises 0.05 m/s<v<1.04 m/s and 0.1 m<γ<1 m.

9. The control method according to claim 7, wherein adjusting the wave energy piezoelectric assembly (3) to the operating state in S2 comprises:
controlling the electric slide rail (5) according to a current wave direction to move the wave energy piezoelectric plate (7) to a position facing the current wave direction;
selecting, according to the current wave direction, the first claw member on a right side of the wave energy piezoelectric plate (7) facing the current wave direction to connect with the wave energy piezoelectric plate (7), releasing other first claw members by disconnecting power supplied to the electromagnetic plate (15), and controlling the fifth hydraulic cylinder (13) and the fourth hydraulic cylinder (12) to extend so as to move the first connecting rod (14) away from the wave energy piezoelectric plate (7) until the connecting shaft (16) disengages from the wave energy piezoelectric plate (7);
disconnecting the power supplied to the electromagnetic plate (15) of the first claw member connected to the wave energy piezoelectric plate (7), rotating the wave energy piezoelectric plate (7) to tilt toward the current wave direction, and then reconnecting the power supplied to the electromagnetic plate (15) of the first claw member so as to fix the wave energy piezoelectric plate (7) at a current position;
controlling the first hydraulic cylinder (8) and the second hydraulic cylinder (9) to lower the wave energy piezoelectric plate (7) until a draft depth of the wave energy piezoelectric plate (7) is one-half of a height of the wave energy piezoelectric plate (7); and
wherein adjusting the wave energy piezoelectric assembly (3) to the stowed state in S2 comprises lifting the wave energy piezoelectric plate (7) to a limit position and then moving the wave energy piezoelectric plate (7) toward the working platform (1) to a stowed position.

10. The control method according to claim 7, wherein adjusting the ocean current energy piezoelectric assembly (4) to the operating state in S2 comprises:
selecting a limiter (23) having a corresponding angle according to a current ocean current velocity, mounting the limiter (23) on the connecting plate (22), and mounting the ocean current energy piezoelectric plate (24) between the two second claw members through the limiter (23) and the slot, wherein when 0.05 m/s<v≤0.4 m/s, the limiter (23) has an angle of 60°, when 0.4 m/s<v≤0.7 m/s, the limiter (23) has an angle of 45°, and when 0.7 m/s<v≤1.04 m/s, the limiter (23) has an angle of 30°;
controlling the motor (18) to move the ocean current energy piezoelectric plate (24) to a position facing the current wave direction according to the current wave direction;
controlling the sixth hydraulic cylinder (19) to lower the ocean current energy piezoelectric plate (24) to an exterior of the bottom chamber (17); and
wherein adjusting the ocean current energy piezoelectric assembly (4) to the stowed state in S2 comprises controlling the sixth hydraulic cylinder (19) to lift the ocean current energy piezoelectric plate (24) into the bottom chamber (17).
